(19) United States
(12) Patent Application Publication
(10) Pub. No.: US 2013/0050128 A1
(43) Pub. Date: Feb. 28, 2013

(54) MULTIPLE ACTUATOR DRIVE CONTROL DEVICE FOR GENERATING A SENSE OF TOUCH

(71) Applicants: Han Eol Bae, Suwon-si (KR); Jun Hyeok Seo, Gunpo-si (KR)

(72) Inventors: Han Eol Bae, Suwon-si (KR); Jun Hyeok Seo, Gunpo-si (KR)

(21) Appl. No.: 13/695,906

(22) PCT Filed: May 4, 2011
(86) PCT No.: PCT/KR11/03340

§ 371 Date: Nov. 2, 2012

(30) Foreign Application Priority Data
May 6, 2010 (KR) 10-2010-0042521

(51) Int. Cl. G06F 3/041

(52) U.S. Cl. 345/173

(57) ABSTRACT

A multiple actuator drive control device for generating a sense of touch, comprising: an interface unit which receives an event-generation signal from a main processor; a parameter storage unit which stores event parameter groups that record event parameters necessary for event generation including channel-specific actuator form data and actuator-form-specific drive frequency data, for generating a sense of touch, and which selects and outputs one of the stored event parameter groups upon receipt of the event-generation signal; an event parameter analysis unit which analyses the event parameters of the event parameter group received from the parameter storage unit; a drive waveform generating unit which generates corresponding drive waveforms specific to each channel in accordance with the channel-specific actuator form and drive frequency data analyzed in the event parameter analysis unit; and an actuator drive unit which drives each of the channel-specific actuators in accordance with the drive waveform. According to the present invention, during the driving of a single actuator, use is made of the drive time, the drive strength and the drive direction by utilizing control parameters on a unfixed frequency, and hence the present invention has the advantageous effect of allowing a new sense of touch to be achieved by controlling actuators by adding control parameters without fixing the frequency.

### BACKGROUND OF THE INVENTION

The invention relates to a multiple actuator drive control device for generating a sense of touch in that at least two actuators, in which properties including an actuating time, a drive strength and a drive response speed etc. are identical with or different from each other, are driven at the same time, so that the user can feel various and real tactility, which it could not feel in the conventional single actuator control device. Also, the present invention is applied to a portable terminal and an electronic product using all actuators including a DC motor, an AC motor and a piezo.

Recently, haptic phones and electronic devices have been released to gain popularity among users. The haptic devices are equipped with haptic functions to generate various haptic rhythms for distinguish and maximize the effects of UI that simply used vibration, ring, or LED lights in case of certain events (pressing buttons or getting phone calls).

The applicant has been registered as a patent registration No. 891145 in that an effect generator using a vibration motor is provided to generate various tactile sense rhythms directly without separate control of a processor, thereby reducing the load of a main processor and improving the efficiency of a main processor.

FIG. 1 is a block diagram illustrating the configuration of the effect generating device using the vibrating motor according to the registered patent. The effect generating device includes a main processor 10, an effect generator 40, a D/A conversion unit 50, a vibrating motor driving controller 60, a vibrating motor 70.

If the main processor 10 transmits the effect generation signal to the effect generator 40 for generating the effect (the sense of touch of the vibrating motor) during the generation of the event, the effect generator 40 extracts and analyzes the effect data stored in advance and the effect digital data corresponding to the analyzed effect data is outputted. The effect generator is connected to the clock generator 30 of applying an external clock and it is synchronized to the external clock to be operated.

The effect generator 40 includes an effect data storage unit 41 for storing the effect data including a parameter information required for the touch rhythm production, that is, the effect generation, a state machine 42 for analyzing the parameter information included in the effect data and then, outputting the effect digital data corresponding to the analyzed parameter information, and a timer unit 43 for applying an interrupt to the main control unit 140 at regular intervals so as to output the effect digital data every interrupts.

The D/A conversion units 50 serves to convert the effect digital data outputted from the state machine 42 into the analog signal and apply it to the vibrating motor driving controller 60. The vibrating motor driving controller 60 serves to receive the analog-converted effect signal and output the motor driving signal corresponding to it. The vibrating motor 70 is driven according to the motor driving signal, thereby generating the tactile sense corresponding to the effect data.

However, in the registered patent, since only the single vibrating motor is driven as the actuator and it controls only the actuating time, the driving direction, the drive strength during the driving of the vibrating motor, there is a limit in which the real feeling or the sense of realism are restricted.

Particularly, since the whole device is vibrated due to the use of the actuator of the single type, it has the limit of providing only the restricted tactile sense.

### SUMMARY OF THE INVENTION

Accordingly, the present invention has been made to solve the above-mentioned problems occurring in the prior art, and an object of the present invention is to provide a multiple actuator drive control device for generating a sense of touch in that a DC or a specific frequency are not fixed during the controlling of each actuator and a variable frequency item is added to the necessary parameter, so that the change of the characteristic of the single actuator can be utilized and the multiple actuators are driven at the same time, so that various properties are combined to implement one tactility, thereby providing broad, various, and improved tactility to the user in comparison with the conventional art.

Another object of the present invention is a multiple actuator drive control device for generating a sense of touch in that a drive waveform generating unit for generating a pattern of considering a driving characteristic of each actuator using a parameter necessary for the driving control is added, so that the burden of a CPU is reduced and a real tactility can be implemented according to a fast feedback, thereby easily and rapidly driving the actuator in comparison with the existed driving method.

In order to accomplish this object, there is provided a multiple actuator drive control device for generating a sense of touch comprising: an interface unit for receiving an event-generation signal from a main processor; a parameter storage unit for storing effect parameter groups that record effect parameters necessary for event generation including channel-specific actuator form information and actuator-form-specific drive frequency information, for generating a sense of touch, and selecting and outputting one of the stored effect parameter groups upon receipt of the event-generation signal; an effect parameter analysis unit for analyzing the effect parameters of the effect parameter group received from the parameter storage unit; a drive waveform generating unit for generating corresponding drive waveforms specific to each channel in accordance with a channel-specific actuator form and drive frequency information analyzed in the effect parameter analysis unit; and an actuator drive unit for driving each of the channel-specific actuators in accordance with the drive waveform.

Preferably, the parameter storage unit comprises an effect parameter group storage unit for storing the effect parameter groups that record the effect parameters necessary for the effect generation and a parameter selection unit for selecting and outputting one of the stored effect parameter groups upon receipt of the event-generation signal. Here, the parameter selection unit receives the effect parameter group select signal through an interface unit and extracts the effect parameter groups corresponding to the receive parameter group select signal to be outputted.

Preferably, each effect parameter group includes a channel-specific main frequency information, a channel-specific variable frequency information, a channel-specific actuator type information, a channel-specific drive basic waveform information, and an channel-specific actuator reaction velocity information. Moreover, each effect parameter group includes an channel-specific actuator reaction operation strength information and a channel-specific actuator operation mode information.

Preferably, the drive waveform generating unit comprises: a basic waveform storage unit for storing a basic waveform for driving each actuator of various types; a main control unit for modulating the basic wave form according to the channel-specific actuator form and the drive frequency information analyzed in the effect parameter analysis unit and generating the drive waveforms specific to each channel; and a channel control unit for outputting the generated channel-specific drive waveforms by corresponding channel.

According to the multiple actuator drive control device for generating the sense of touch, during the driving of a single actuator, use is made of the drive time, the drive strength and the drive direction by utilizing control parameters on a fixed frequency, and hence the present invention has the advantageous effect of allowing a new sense of touch to be achieved by controlling actuators by adding control parameters without fixing the frequency.

Also, the actuators having different driving characteristics in terms of the physical process technology, for example, the DC motor and AC motor, the AC motor and piezo etc. are driven at the same time, so that the user can feel various and real tactility, which it could not feel in the conventional single actuator control device.

Moreover, the drive waveform generating unit for generating the pattern of considering the driving characteristic of each actuator using the parameter necessary for the driving control is equipped, so that the burden of a CPU is reduced and a rapid tactile response can be implemented. Furthermore, the user easily drives the actuator and develops the system.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration of a conventional effect generating device using the vibrating motor;

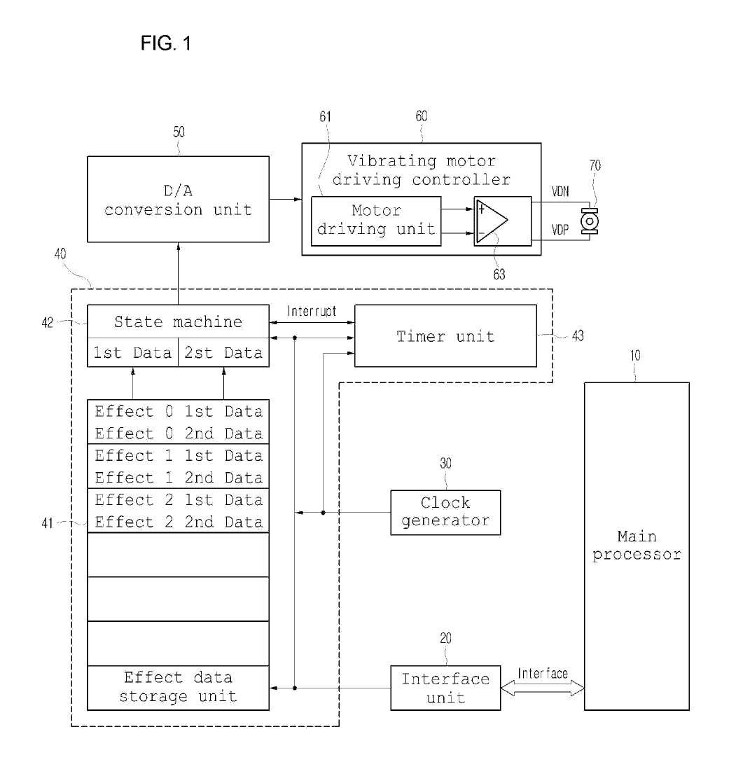

FIG. 2 is a block diagram illustrating a multiple actuator drive control device for generating a sense of touch according to the present invention;

FIG. 3 is a block diagram illustrating an internal configuration of a parameter storage unit; and

FIG. 4 is a block diagram illustrating an internal configuration of a drive waveform generating unit.

<Descriptions on reference numbers for the major components in the
drawings>

| | |
|---|---|
| 1: main processor | 2: interface unit |
| 3: parameter storage unit | 4: effect parameter analysis unit |
| 5: drive waveform generating unit | |
| 6: D/A conversion unit | 7: actuator drive unit |
| 8: actuator | |
| 100: effect parameter group storage | |
| unit | |
| 110: effect parameter selection unit | |
| 120: timer unit | 130: basic waveform storage |
| 140: main control unit | 150: channel control unit |

### DETAILED DESCRIPTION OF THE INVENTION

Hereinafter, an exemplary embodiment of the present invention will be described in detail with reference to the accompanying drawings.

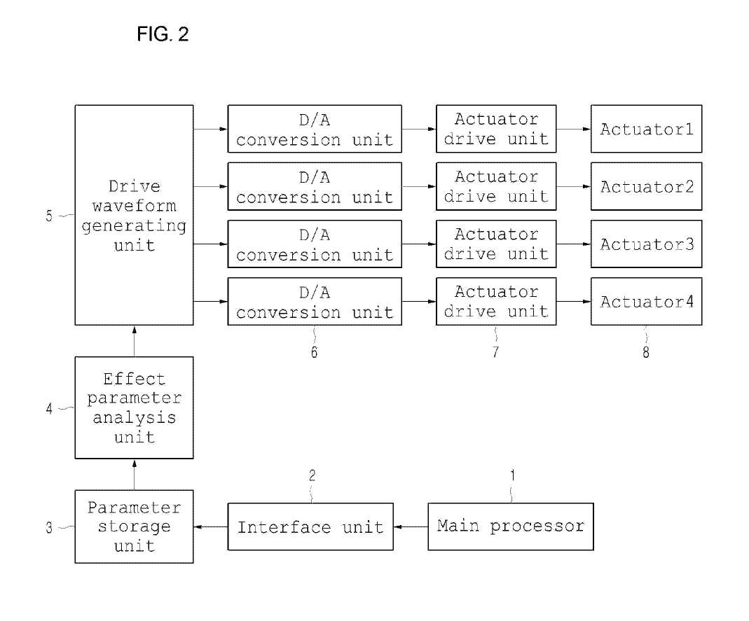

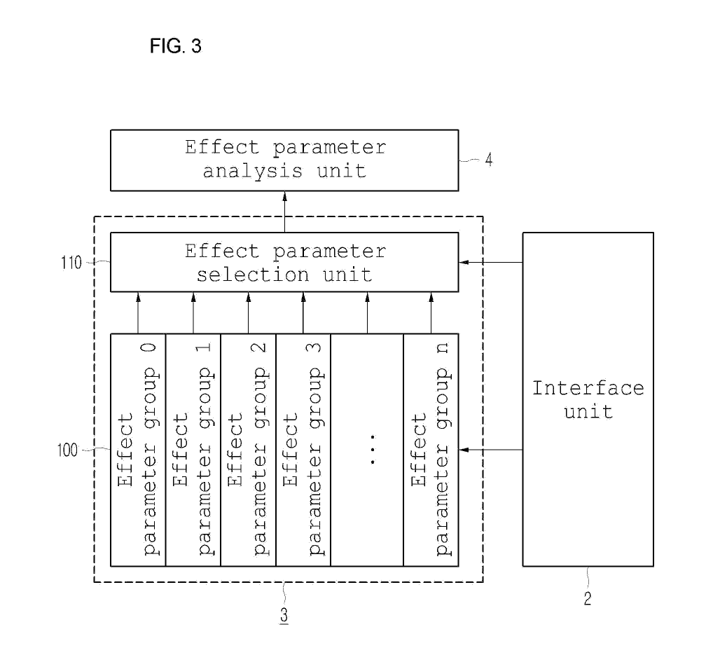

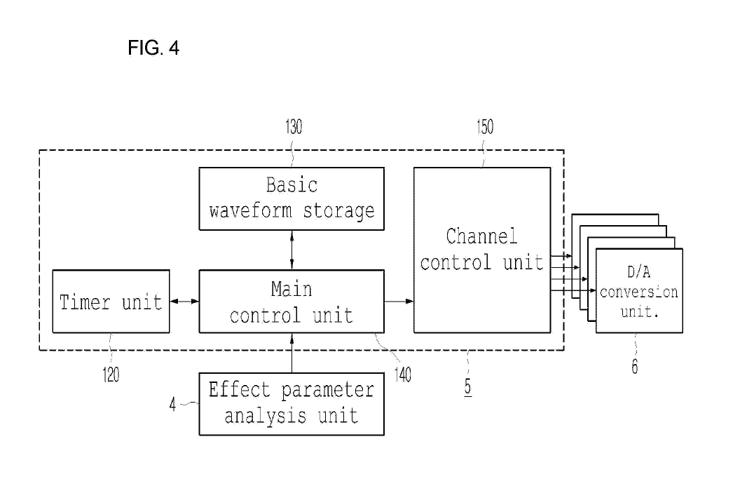

FIG. 2 is a block diagram illustrating a multiple actuator drive control device for generating a sense of touch according to the present invention, FIG. 3 is a block diagram illustrating an internal configuration of a parameter storage unit, and FIG. 4 is a block diagram illustrating an internal configuration of a drive waveform generating unit.

As described in FIG. 2, the multiple actuator drive control device for generating a sense of touch according to the present invention includes an interface unit 2, a parameter storage unit 3, an effect parameter analysis unit 4, a drive waveform generating unit 5, a D/A conversion unit 6, and an actuator drive unit 7.

The interface unit 2 serves to provide the interface between the multiple actuator drive control device and the main processor 1. The interface unit 2 serves to receive an event-generation signal including the effect parameter group selection information from a main processor 1 and transmit it to the parameter storage unit 3.

The parameter storage unit serves to store effect parameter groups that record effect parameters necessary for effect generation, for generating the sense of touch, and select and output one of the stored effect parameter groups upon receipt of the event-generation signal.

Referring to FIG. 3, the parameter storage unit 3 includes an effect parameter group storage unit 100 for storing the effect parameter groups that record the effect parameters necessary for the effect generation and a parameter selection unit 110 for selecting and outputting one of the stored effect parameter groups upon receipt of the event-generation signal.

Besides the mode of selectively outputting at least one of the stored effect parameter groups, it is possible for the effect selecting unit 110 to output the stored effect parameter groups in order.

Here, the effect parameter groups include 16 kinds of parameters as described in the following table 1. The meaning of each parameter is illustrated in the table 1.

Referring to table 1, in the present invention, new parameters, which is not be used in the conventional art, that is, a channel-specific main frequency information, a channel-specific variable frequency information, a channel-specific actuator type, a channel-specific drive basic waveform information, a channel-specific actuator reaction velocity information, a channel-specific actuator reaction operation strength information, and a channel-specific actuator operation mode information etc. are added, so that it can utilize the change of the vibration property according to the variable frequency within the single actuator. Also, since the multiple actuators are driven at the same time, one sense of touch having various vibration properties is implemented, thereby providing broad, various, and improved tactility to the user.

TABLE 1

| Parameters | Explanation |
|---|---|
| Start count information | Start duration time of Vibration |
| Start strength information | Strength (amplitude) of initial |
| | vibration |
| Start variation information | Increase status or Decrease status |
| | of initial waveform |
| Start maintenance time | Strength (amplitude) of initial |
| information | vibration |
| Rotation information | Rotation direction of motor |
| End variation information | Increase status or Decrease status |
| | of last waveform |
| End strength information | Strength (amplitude) of last |
| | vibration |
| End maintenance time | Duration time of last vibration |
| information | |
| Repeat information | Repeat count of waveform |
| End count information | End duration time of Vibration |
| Channel-specific main | Main drive frequency by each |
| frequency information | actuator corresponding channel |
| Channel-specific variable | Frequency variable quantity by each |
| frequency information | actuator corresponding channel |
| Channel-specific actuator | Type information including a DC |
| type information by channel | motor, AC motor, piezo etc. |
| Drive basic waveform | DC voltage, sinusoidal wave, square |
| information by channel | wave, ladder waver, and processed |
| | square wave etc. |
| Channel-specific actuator | Reaction speed by actuator type |
| reaction speed information | |
| Channel-specific actuator | Actuator reaction operation |
| reaction operation strength | strength during applying of square |
| information | wave |
| Channel-specific actuator | Operation according to single |
| operation mode information | voltage displacement or double |
| | voltage displacement |

For example, a fast frequency gives a light feeling, meanwhile, a slow frequency gives a heavy feeling. Also, a mixed frequency or a variable frequency gives a mixed feeling.

In case of the basic drive waveform by channel, the piezoelectric element exhibits a sinusoidal wave and the vibrating motor exhibits a square wave or an information on basic drive waveforms suitable for the type of each actuator with the DC voltage etc.

Since the reaction speed and the reaction operation strength are different during the applying of the drive waveform every actuator, it is desirable that the drive waveform is varied according to the parameter values. For example, where the vibrating motor is driven together with the piezoelectric element, it is just reacted during the applying of the drive waveform. Meanwhile, in case of the vibrating motor, the delay time is somewhat generated until the reaction thereof after the applying of the drive waveform. Accordingly, it is preferred that the cycle for driving the piezoelectric element is synchronized to the vibrating motor in the drive waveform of the piezoelectric element or the amplitude of the waveform is appropriately controlled according to the reaction operation strength.

The effect parameter analysis unit 4 serves to analyze the effect parameters of the effect parameter group received from the parameter storage unit and transmit them to the drive waveform generating unit 5.

The drive waveform generating unit 5 serves to generate corresponding drive waveforms specific to each channel in accordance with a result analyzed in the effect parameter analysis unit.

Referring to FIG. 4, the drive waveform generating unit 5 includes s timer unit 120, a basic waveform storage unit 130, a main control unit 140, and a channel control unit 150.

The timer unit 120 serves to apply an interrupt to the main control unit 140 at regular intervals so as to generate the effect drive waveform every interrupts.

The basic waveform storage unit 130 serves to store the basic waveform for producing the effect pattern. The basic waveforms including the DC voltage, the sinusoidal wave, the square wave, the ladder wave, the square wave etc. are stored therein. The piezoelectric element exhibits the sinusoidal wave and the vibrating motor exhibits the square wave or the information on the basic drive waveforms suitable for the type of each actuator with the DC voltage etc.

The main control unit 140 serves to generate the effect drive waveform according to the effect parameter values received from the parameter analysis unit 4. After the main control unit 140 extracts the corresponding basic waveform from the basic waveform storage unit 130 based on the drive basic waveform information by channel, the basic waveform is modulated according to the rest parameter information, thereby generating the specific effect drive waveform. The main control unit 140 receives the analyzed result of the effect parameter group as much as the number of channel from the parameter analysis unit 4, generates the effect drive waveform corresponding to the number of the channel according to the parameter value within each effect parameter group, and transmits the generated effect drive waveform along with the channel information to the channel control unit 150.

If the channel control unit 150 receives the channel information and the effect drive waveform from the main control unit 140, the corresponding effect drive waveforms specific to each channel are outputted.

The D/A conversion units 6 are equipped every channel. It serves to convert the effect drive waveform of the digital format outputted from the channel control unit 150 into the analog signal. The actuator drive unit 7 serves to operate each actuator by channel according to the drive waveform of the converted analog type.

Hereinafter, the operation of the multiple actuator drive control device is illustrated with reference to FIG. 2 to FIG. 4.

Where the event for providing the sense of touch is generated (the user contacts the touch screen or it gets a phone call etc.), the main processor 1 transmits the event generation signal through the interface unit 2. At this time, the main processor 1 can transmit the selection signal for the effect pattern selection together.

When the event generation signal is received from the main processor 1, the parameter storage unit 3 selectively outputs the effect parameter groups corresponding to the effect pattern selection signals. When the effect pattern selection signals are not received from the main processor 1, the stored effect parameter groups are outputted in order. At this time, the numbers of the outputted effect parameter groups can be the same as those of the actuators. Where a plurality of actuators of the same type is existed, the numbers of the outputted effect parameter groups can be the same as those of the actuator type.

The effect parameter analysis unit 4 analyzes the parameters within the outputted effect parameter groups and provides them to the drive waveform generating unit 5. The drive waveform generating unit 5 analyzes the parametric values and modulates the basic waveforms fitting for the actuator to output them according to each channel, thereby driving each actuator by channel.

As described above, each actuator by channel is driven according to the basic waveform, the main frequency, and the cycle suitable for each actuator 8 and the drive frequency is varied, thereby more various and real sense of touch can be provided.

Although a preferred embodiment of the present invention has been described for illustrative purposes, those skilled in the art will appreciate that various modifications, additions and substitutions are possible, without departing from the scope and spirit of the invention as disclosed in the accompanying claims.

The present invention relate to a multiple actuator drive control device for generating a sense of touch in that at least two actuators, in which properties including an actuating time, a drive strength and a drive response speed etc. are identical with or different from each other, are driven at the same time, so that the user can feel various and real tactility, which it could not feel in the conventional single actuator control device.

1. A multiple actuator drive control device for generating a sense of touch comprising:
an interface unit for receiving an event-generation signal from a main processor;
a parameter storage unit for storing effect parameter groups that record effect parameters necessary for effect generation including channel-specific actuator form information and actuator-form-specific drive frequency information, for generating a sense of touch, and selecting and outputting one of the stored effect parameter groups upon receipt of the event-generation signal;
an effect parameter analysis unit for analyzing the effect parameters of the effect parameter group received from the parameter storage unit;
a drive waveform generating unit for generating corresponding drive waveforms specific to each channel in accordance with a channel-specific actuator form and drive frequency information analyzed in the effect parameter analysis unit; and
an actuator drive unit for driving each of the channel-specific actuators in accordance with the drive waveform.

2. A multiple actuator drive control device for generating a sense of touch as claimed in claim 1, wherein the parameter storage unit comprises;
an effect parameter group storage unit for storing the effect parameter groups that record the effect parameters necessary for the effect generation; and
a parameter selection unit for selectively or gradually outputting at least one of the stored effect parameter groups upon receipt of the event-generation signal.

3. A multiple actuator drive control device for generating a sense of touch as claimed in claim 2, wherein the parameter selection unit receives the effect parameter group select signal through an interface unit and extracts the effect parameter groups corresponding to the receive parameter group select signal to be outputted.

4. A multiple actuator drive control device for generating a sense of touch as claimed in claim 2, wherein each effect parameter group includes a channel-specific main frequency information, a channel-specific variable frequency information, a channel-specific actuator type information, a channel-specific drive basic waveform information, and an channel-specific actuator reaction velocity information.

5. A multiple actuator drive control device for generating a sense of touch as claimed in claim 2, wherein each effect parameter group includes an channel-specific actuator reaction operation strength information and a channel-specific actuator operation mode information.

6. A multiple actuator drive control device for generating a sense of touch as claimed in claim 1, wherein the drive waveform generating unit comprises:
a basic waveform storage unit for storing a basic waveform for driving each actuator of various types;
a main control unit for modulating the basic wave form according to the channel-specific actuator form and the drive frequency information analyzed in the effect parameter analysis unit and generating the drive waveforms specific to each channel; and
a channel control unit for outputting the generated channel-specific drive waveforms by corresponding channel.
